(19) United States
(12) Patent Application Publication
(10) Pub. No.: US 2010/0031589 A1
(43) Pub. Date: Feb. 11, 2010

(54) Tower and wind turbine supporting structures and method for mounting the latter

(76) Inventors: Christopher M. Fernald, Enfield, CT (US); Russel Hugh Marvin, Goshen, CT (US); Bret Thomas Sleicher, Naugatuck, CT (US)

Correspondence Address: Ted Paulding, 10 Penwood LA., Wethersfield, CT, 06109, US

(21) Appl. No.: 12/460,985

(22) Filed: Jul. 27, 2009

Related U.S. Application Data
(63) Continuation-in-part of application No. 12/217,916, filed on Jul. 9, 2008.
Application No. 12/217,916 is a continuation-in-part of application No. 12/077,556, filed on Mar. 20, 2008.
Application No. 12/077,556 is a continuation-in-part of application No. 12/006,024, filed on Dec. 28, 2007.

(51) Int. Cl. F03D 11/04; E04H 12/00; E04H 12/08; E02D 27/12; E02D 27/42

(52) U.S. Cl. 52/173.1; 52/651.01; 52/653.2; 52/169.9; 52/745.17; 52/299; 52/742.14

(57) ABSTRACT

A tower and wind turbine supporting structure which at least partially envelops the tower. The tower is of uniform cross sectional configuration throughout and has a plurality of outriggers. The outriggers are connected with the tower after the wind turbines and their supporting structure have been positioned at the base of the tower, raised to their point of attachment and secured in place. Individual foundation members for each vertical tower member and for each outrigger are in the form of micro piles and may include a plurality of micro piles and a manifold for maintaining upper end portions thereof in desired positions. Another aspect of the method of the invention involves providing a tower of uniform cross section, positioning wind turbines and their supporting structures sequentially at the base of the tower, raising them and mounting them on the tower sequentially, and thereafter providing a plurality of outriggers and their foundations and attaching them to the tower.

### RELATED APPLICATIONS

This application is a Continuation-in-Part of U.S. patent application Ser. No. 12/217,916 entitled TOWER AND WIND TURBINE SUPPORTING STRUCTURES AND METHOD FOR MOUNTING THE LATTER, FILED Jul. 9, 2008, invented by Russel H. Marvin et al,

U.S. patent application Ser. No. 12006024 entitled IMPROVED INLET PASSAGEWAY AND SEALING IN A TURBINE WIND POWER GENERATING SYSTEM filed Dec. 28, 2007, invented by Russel H. Marvin, hereby incorporated herein by reference, and
U.S. patent application Ser. No. 12077556 entitled ACCELERATOR FOR USE IN A WIND POWER ELECTRICAL GENERATING SYSTEM, filed Mar. 28, 2008 invented by Russel H. Marvin, also incorporated herein by reference.

### BACKGROUND OF THE INVENTION

The construction of wind turbines and associated apparatus on supporting towers at elevations reaching hundreds of feet is a difficult, dangerous and very expensive proposition. Further, the massive foundations required for the exceptionally high towers are also a major component of the overall cost of wind turbine generation of electrical power.

Accordingly, it is a general object of the present invention to provide a tower and wind turbine supporting structure configuration and a method of mounting wind turbines and their supporting structures on the tower which dramatically reduces the overall cost of construction of a wind turbine electrical generating system.

A further object of the invention resides in the provision of an improved foundation system which can be installed employing a relatively simple process involving a minimum number of steps at substantial economic advantage and which is yet highly efficient and efficient in operation.

### SUMMARY OF THE INVENTION

In accordance with the present invention and in fulfillment of the foregoing object a tower is provided for mounting wind turbines and their supporting structures which at least partially envelop the tower at elevated positions for enhanced wind velocities. The tower comprises a plurality of horizontally spaced apart vertically extending narrow elongated and lightweight main members and a plurality of shorter narrow lightweight interconnecting cross members extending between the vertical members and cooperating therewith to form a massive monolithic structure having a vertical dimension of at least thirty (30) feet. In the illustrative embodiment of the invention shown and described herein below a tower of two hundred (200) feet in height is provided and the exterior cross sectional configuration and dimensions of the tower from its base to the area of attachment of the wind turbine supporting structures is substantially uniform. A power operated lifting device is provided at the base or the top of the tower as shown and has at least one (1) connected lift line, two (2) shown. Adjacent the base of the tower a plurality of diagonally extending outriggers are also provided for attachment to the tower after the turbines and their supporting structures have been positioned adjacent the tower at its base, raised by the power lifting device, and secured in place at their respective operating positions.

The outriggers are spaced apart horizontally about the tower and each is of narrow elongated and lightweight but rigid construction longitudinally providing support against both tension and compression loading. Each outrigger has its upper end portion connected to the tower in supporting relationship therewith and its lower end portion is disposed in horizontally spaced relationship with the tower at least approximately at ground level.

Finally, a foundation system is provided and supports each vertical member of the tower and each outrigger individually at its lower end portion. More particularly, the foundation system preferably comprises an individual foundation for each tower and outrigger member supported thereby, each foundation system including a member of narrow elongated configuration and of composite metallic and concrete construction. The elongated foundation members extend downwardly from their supported members into the earth a substantial distance and provide effective resistance against both compression and tension forces Micro piles are presently preferred.

In another embodiment of the invention, the vertical members of the tower and the outriggers may be supported by micro piles extending from their supported members to anchors in bedrock which is reasonably close to the surface.

In an alternative embodiment of the invention three (3) micro piles are provided for each main structural member of the tower and each outrigger and have associated manifolds which receive the inner members of the micro piles through openings and maintain the same in a desired “splayed” configuration. The manifolds also serve as guides during drilling and other activity occurring in formation of the foundations with the inner members of the micro piles passing through their openings and properly aligned and guided thereby.

Preferably, the wind turbine and support structures carry a pair of turbines on opposite sides of the support structure with a pair of wind accelerating surfaces or passageways respectively capturing and accelerating a flow of wind to the turbines. A wide variety of wind turbine and supporting structures may be employed but the turbine and support structure or “accelerator” design of the aforementioned patents is presently preferred. In this embodiment a cylindrical supporting structure completely surrounds the tower and the tower is of substantially uniform cross section throughout its height. In other embodiments of the invention when the tower may for example have a rectangular cross section with wind turbine supporting structures of generally U-shaped or parti-circular cross section, the relationship between the tower and the supporting structures is established such that the tower exterior dimensions are less than those of the supporting structures at least in the areas where they reside in adjacent relationship during raising and assembly. Thus, for example the fourth exposed side of a rectangular tower may take a completely irregular configuration.

In accordance with a method of the invention a tower of the desired height and substantially uniform cross section from its base to the desired area of attachment of the wind turbines and their supporting structures is first constructed. At least one wind turbine and its assembled supporting structure is then positioned on the ground adjacent the base of the tower. The wind turbine and support structure is thereafter raised to its desired point of attachment and secured in place. At least three diagonal outriggers and their respective foundations are then provided and the upper end portions of the outriggers are connected to the tower in spaced relationship thereabout, the lower end portions of the outriggers being attached to their respective foundations.

When each wind turbine and supporting structure comprises a pair of turbines arranged on opposite sides thereof the turbines are spaced apart between 150 and 210 degrees and are approximately one hundred and seventy (170) degrees apart in the presently preferred embodiment of the invention. Each supporting structure at least partially envelops the tower and provides at least one surface to capture the wind and accelerate flow to the turbines. Further, when a plurality of wind turbines and supporting structures are provided, the wind turbines and supporting structures are disposed sequentially adjacent the base of the tower, raised sequentially to their desired positions and attached proceeding from the uppermost wind turbine and supporting structure downwardly to the lowermost.

As will be apparent, the method of the invention accommodates the construction of the wind turbines and their supporting structures on the ground and thus avoids the excessive labor and/or crane costs encountered with construction at high elevations.

Optionally, the wind turbines and supporting structures may be manufactured completely on site or manufactured in sections off-site, transported to the site and thereafter assembled sequentially adjacent the tower base.

### DESCRIPTION OF THE DRAWINGS

FIG. 1 is a somewhat schematic elevation showing a tower without outriggers during practice of the method of the invention, a wind turbine and its supporting structure being shown at the base of the tower and a power lifting device at the top of the tower.

FIG. 2 is a view in elevation similar to FIG. 1 but showing the tower, wind turbines and supporting structures mounted thereon, outriggers in place about the base of the tower with foundation members supporting the tower and outriggers, and

FIG. 3 is a fragmentary view in elevation showing a lower portion of the tower and outriggers in greater detail.

FIG. 4 is an enlarged fragmentary perspective view showing a manifold and lower end portions of an outrigger comprising three (3) tubular members with a three member foundation, and

FIG. 5 is an enlarged fragmentary perspective showing a manifold and a connecting bracket associated with a three member foundation and main structural member of a tower, and

FIG. 6 is a fragmentary sectional view showing a guide and manifold with associated foundation members during drilling and formation of the micro pile.

### DESCRIPTION OF PREFERRED EMBODIMENTS

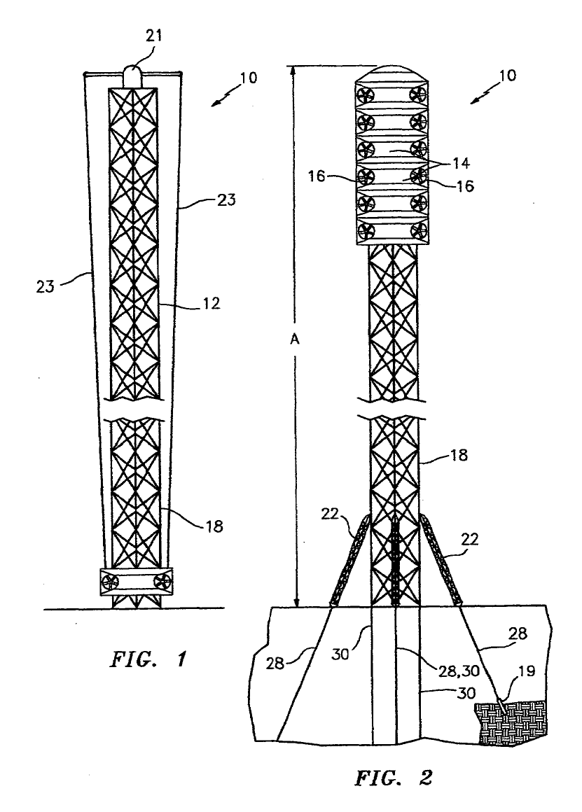

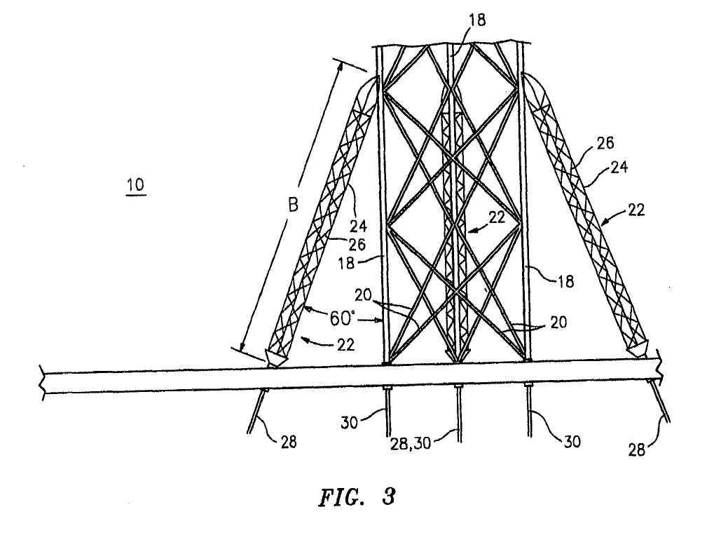

Referring in particular to FIGS. 1 and 2, a tower for mounting wind turbines and their supporting structures is indicated generally at 10 with the tower proper at 12, supporting structures at 14,14 and turbines at 16,16. The illustrative tower 12 shown has a height A of approximately two hundred (200) feet. As best illustrated in FIG. 3, the tower 12 includes a plurality of narrow elongated vertically extending main longitudinal members 18,18, preferably tubular, and a plurality of shorter narrow interconnecting cross members 20,20. The cross members 20,20 may be tubular or triangular in cross section in a truss structure. The members 20,20 extend between the members 18,18 and cooperate therewith to form a massive monolithic structure having a vertical dimension of at least fifty (50) feet, 200 feet as shown and mentioned above. The cross sectional configuration and other structural characteristics of the tower may vary but in all cases the cross sectional dimensions and configuration of the tower from its base to the area of connection with the wind turbine supporting structures must be at least partially uniform to permit raising of the wind turbines and their supporting structures thereabout. The tower 12 is of a presently preferred triangular vertically uniform cross sectional configuration with the short cross members 20,20 extending diagonally between the vertical members 18,18.

Mounted at or near the top of the tower is a power operated lifting device 21 which is shown with a pair of depending lift lines 23,23 respectively on opposite sides of the tower 12 and connected with a wind turbine supporting structure 14 at the base of the tower.

The wind turbines 16,16 and their supporting structures 14,14 may vary widely in construction but as mentioned above are preferably of the cylindrical type disclosed in the aforementioned patents and completely surround the tower 12. It should also be noted that the supporting structures are mounted for incremental rotation about the tower in adjusting the position of the turbines for optimum performance in response to changes in the direction of wind flow.

As best illustrated in FIG. 3, a plurality of longitudinally rigid outriggers are provided for support in both tension and compression. As shown, three (3) outriggers 22,22 are provided and each outrigger 22 is of tubular metallic construction with three (3) longitudinally extending elongated tubular members 24,24 in a triangular configuration and with a plurality of shorter tubular members 26,26 interconnecting the longitudinal members. The outriggers 22,22 have their upper end portions connected in supporting relationship with the vertical longitudinally members of the tower; three (3) outriggers being provided for the triangular tower 12. Preferably, the connection of the outriggers with the tower is effected at the point where at least one cross member 20 also connects with a vertical member 18. The outriggers have a length B in the range twenty (20} to one hundred (100) feet and, in the illustrative embodiment shown, the outriggers have a length B of approximately fifty (50) feet. The outriggers are at an angle with the vertical in the range of thirty (30) to eighty (80) degrees, the preferred angle being approximately sixty (60) degrees.

At lower end portions the outriggers 22,22 are preferably provided with separate foundation members in the form of elongated members 28,28 of composite metallic and concrete construction. As shown, the foundation members 28,28 take the form of micro piles of the type sold and installed by CON-TECH K SYSTEMS LTD. of 8150 River Road, Delta, B.C. Canada V4G 1B5 under the trademarks SCHEBECK and TITAN and extend downwardly into the earth at angles substantially the same as that of the members which they support. The length of the micro pile members should be in the range of twenty (20) to fifty (50) feet and in the illustrative embodiment shown, the outrigger foundation members 28.28 are approximately thirty (30) feet long.

When bedrock is reasonably close to the surface, the foundation members 28,28 may be supported by anchors 19 embedded in the bedrock, one shown on the right hand member 28 in FIG. 2.

Foundation members 30,30 for the vertical members 18,18 of the tower 12 are preferably the same as those for the outriggers with the length of the members falling in the range of twenty (20) to fifty (50) feet. In the illustrative embodiment shown the length of the members 30,30 is approximately thirty (30) feet and the members extend vertically, downwardly from the vertical members which they support.

In accordance with the method of the invention, and as mentioned above, a tower at least partially uniform in cross section is provided and the wind turbines and their supporting structures are positioned at the base of the tower, raised to the area of attachment, and secured in place. When twin turbines are provided, the supporting structures at least partially envelope the base of the tower and may be manufactured off-site in sections and assembled around the tower base, or they may be manufactured on site about the tower base. Thereafter, when all of the wind turbine and supporting structures have been raised and secured in place, the outriggers may be assembled with the tower and their foundations to complete the installation.

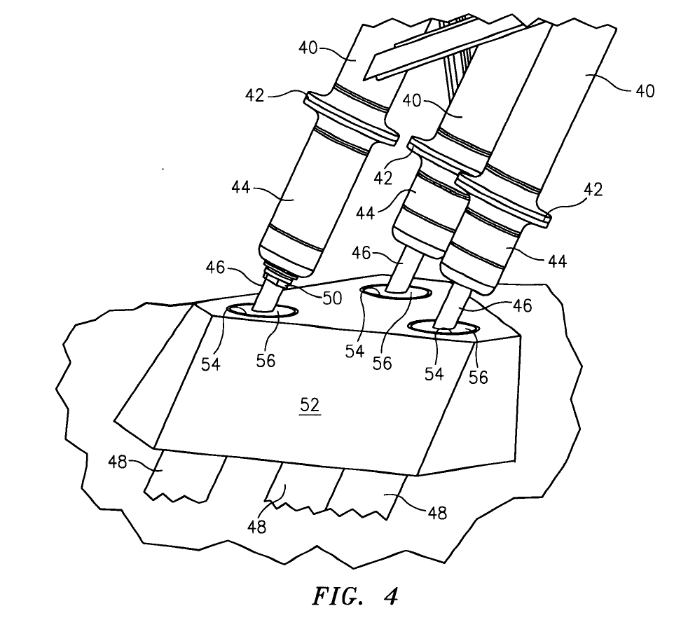

FIG. 4 et sequa illustrate an alternative embodiment of the invention with improved foundation systems providing a higher degree of structural integrity and superior stability for the tower and its wind turbines even in hurricane conditions. Referring particularly to FIG. 4, lower end portions 40, 40 of three (3) elongated tubular members forming an outrigger are shown connected by flanges 42, 42 with short tubular connecting tubes 44, 44. The connecting tubes are open at their lower ends and receive upper end portions of tubular metallic inner members 46, 46 of micro piles 48, 48. External nuts 50, 50, one shown, cooperate with nuts internally of the connecting tubes together with bearing plates in affecting connections between the outriggers 40, 40 and the tubular inner members 46, 46 of the micro piles.

A manifold 52, which is preferably of precast concrete, has three (3) openings 54, 54 for receiving the inner members 46, 46 of the micro piles. A hardenable medium 56 fills the gaps between the walls of the openings 54, 54 and the tubular micro pile members 46, 46, the former being somewhat larger in diameter than the latter.

As will be apparent from the forgoing, the upper end portions of the tubular members 46, 46 of the micro piles are maintained in desired pre-determined positions by means of the manifold 52, and as will be described herein below, the manifold 52 also serves as a guide during the formation of the micro piles whereby to establish desired predetermined angular relationships of the micro piles.

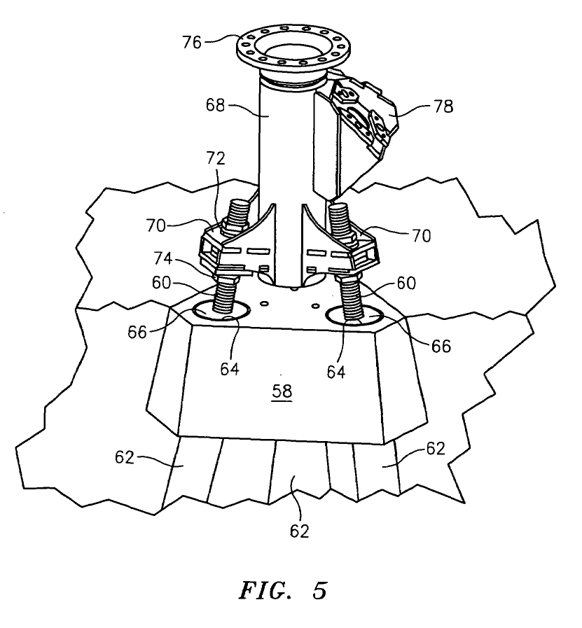

In FIG. 5, a manifold 58 is shown for establishing connection of tubular upper end portions 60, 60 of micro piles 62, 62. The manifold 58 is also constructed of precast concrete in presently preferred form and has three through openings 64, 64, two shown, for receiving the tubular inner members 60, 60 of the micro piles. A hardenable medium 66, 66 fills gaps between the tubular members 60, 60 and the walls of the openings 64, 64. At upper end portions, the members 60, 60 are connected with a manifold type bracket 68 which has three (3) flanges 70, 70, two shown. The flanges 70, 70 have openings for receiving the members 60, 60 and associated upper and lower nuts 72, 74 secure the members 60, 60 in the openings in the flanges 70, 70. At its upper end, the manifold type bracket 68 carries a large flange 76 for connection with a main vertical structural member of a wind turbine tower. An associated truss member may be connected with the bracket 78.

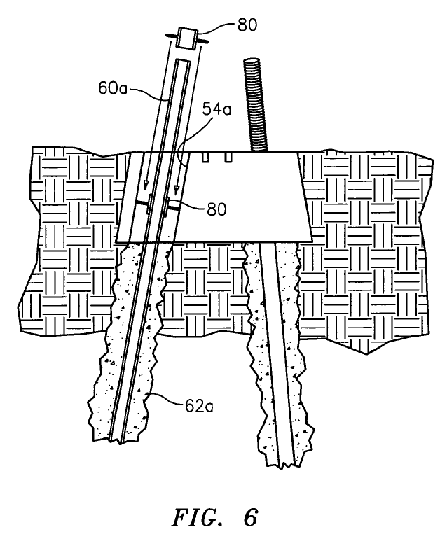

The micro piles 48, 48 and 62, 62 extend a substantial distance downwardly into the earth and are between 20 and 50 feet in length, preferably approximately 30 feet long for both the outriggers and the main structural members of the tower. Further, the micro plies extend in a “splayed” relationship with each other, FIG. 6, for maximum effectiveness in both compression and tension. The angular relationship of the micro piles with respect to the centerlines of their supported members may vary but it is preferred to maintain a displacement of approximately 3 degrees from the centerlines of the outriggers and a displacement of approximately 10 degrees from the centerlines of the structural members of the towers.

Referring now to FIG. 6, the template function of the manifolds 52, 58 is illustrated subsequent to the drilling operation and the injection of concrete through a tube such as 60a. The tube 60a may be entered in an opening 54a and maintained in position on completion of drilling and concrete injection by means one or more small inserts 80, 80 positioned in the opening 54a. A first insert 80 is shown in the opening 54a in FIG. 6 and a second insert 80 is shown above the upper end of the tube 60a. As will be apparent, the inserts 80, 80 will serve to maintain the tubular member 60a in a desired angular position when drilling and formation of the micro pile is complete with the concrete remaining in an unhardened condition. The inserts 80, 80 are retained in the opening 54a during grouting of the opening 54a with hardenable medium and insure precise final positioning of the upper ends of the members 60a, 60a for connection with their respective supported members.

As will be apparent from the forgoing, both an improved tower and an improved foundation system have been provided with substantial savings achieved particularly in the foundation system.

The erection method of the invention also provides for substantial savings in avoidance of the excessive cost of labor and large cranes for assembly or repair of the wind turbines and supporting structures at high elevations.

1. A tower and wind turbine supporting structure which at least partially envelops the tower at an elevated position for enhanced wind velocity; the tower comprising a plurality of horizontally spaced apart vertically extending narrow elongated and lightweight members and a plurality of shorter narrow lightweight interconnecting cross members extending between the vertical members and cooperating therewith to form a massive monolithic structure having a vertical dimension of at least thirty five (35) feet, the exterior cross sectional configuration and dimensions of the tower from its base to the area of attachment of the wind turbine supporting structure being less than that of the adjacent interior cross sectional surfaces of the wind turbine supporting structure, at least one power operated lifting device and at least one lift line connected therewith and extending downwardly from the top of the tower, a plurality of diagonally extending outriggers adapted to be attached to the tower after the turbine and supporting structure has been positioned at the base of the tower, raised to its respective operating position by said lifting device and secured in place, the outriggers being spaced apart horizontally about the base of the tower and each being of narrow elongated and lightweight but longitudinally rigid construction, each outrigger having its upper end portion connected to the tower in supporting relationship therewith and its lower end portion disposed in horizontally spaced relationship with the tower at least approximately at ground level, and a foundation system supporting each vertical structural member of the tower and each outrigger at its lower end portion.

2. A tower and wind turbine supporting structure as set forth in claim 1 wherein the cross section of the tower is substantially uniform from its base to the point of attachment of the wind turbine supporting structure.

3. A tower and wind turbine supporting structure as set forth in claim 1 wherein the supporting structure completely surrounds the tower and all exterior cross sectional dimensions of the tower are less than those of the interior dimensions of the supporting structure.

4. A tower and wind turbine supporting structure as set forth in claim 1 wherein the tower is adapted to mount turbine support structures which have at least one wind directing surface leading to a pair of wind turbines on opposite sides of the support structure.

5. A tower and wind turbine supporting structure as set forth in claim 1 wherein the tower has a triangular cross sectional configuration, and wherein the vertical members thereof are tubular in cross section.

6. A tower and wind turbine supporting structure as set forth in claim 1 wherein the outriggers have a triangular cross sectional configuration.

7. A tower and wind turbine supporting structure as set forth in claim 6 wherein each outrigger is constructed of tubular metallic structural members with three (3) longitudinally extending elongated tubular members in a spaced apart triangular configuration and a plurality of short tubular cross members interconnecting the longitudinal members.

8. A tower and wind turbine supporting structure as set forth in claim 1 wherein the outriggers have their upper end portions connected with the tower at substantially the same height as the attachment of at least one of the tower cross members to a vertical longitudinal tower member.

9. A tower and wind turbine supporting structure as set forth In claim 1 wherein the vertical longitudinal members of the tower and the outriggers are each supported individually at lower end portions by discrete foundation members.

10. A tower and wind turbine supporting structure as set forth in claim 9 wherein each of the foundation members is a narrow elongated member of composite metallic and concrete construction, each foundation member having its upper end portion connected in supporting relationship with its supported member and extending downwardly into the earth a substantial distance therefrom.

11. A tower and wind turbine supporting structure as set forth in claim 10 wherein each foundation member is a micro pile.

12. A tower and wind turbine and their supporting structures as set forth in claim 10 wherein each foundation member extends downwardly into the earth at substantially the same angle as the member supported thereby.

13. A tower and wind turbine supporting structure as set forth in claim 1 wherein the tower is approximately two hundred (200) feet in height, the outriggers are approximately fifty (50) feet in length, and the angle between the outriggers and the vertical is between forty (40) and eighty (80) degrees.

14. A tower and wind turbine supporting structure as set forth in claim 13 wherein the angle between the outriggers and the vertical is approximately sixty (60) degrees.

15. A tower and wind turbine supporting structure as set forth in claim 1 wherein at least one of the foundation members for the vertical members of the tower and the outriggers is supported on bed rock.

16. A method for mounting wind turbines and supporting structures which at least partially envelop a tower at elevated positions on the tower for enhanced wind velocities, said method comprising the steps of constructing a tower of the desired height and of cross sectional dimensions from its base to the desired point of attachment which are less than those of the adjacent interior surfaces of the wind turbine supporting structures, positioning a wind turbine and supporting structure adjacent the base of the tower, raising the wind turbine and supporting structure to its desired elevation and mounting the same on the tower, providing at least three diagonal outriggers and foundations therefore, attaching upper end portions of the outriggers to the tower in spaced relationship thereabout, and attaching the lower end portions of the outriggers to their respective foundations.

17. A method as set forth in claim 16 wherein a plurality of wind turbines and supporting structures are provided, and wherein the wind turbines and supporting structures are disposed sequentially at the base of the tower and raised to their mounting positions sequentially proceeding from the uppermost wind turbine and supporting structure downwardly to the lowermost.

18. A method as set forth in claim 16 wherein each wind turbine and supporting structure comprises a pair of turbines spaced approximately one hundred fifty (150) to two hundred ten (210) degrees apart, and wherein each supporting structure at least partially envelopes the tower and provides at least one wind flow directing surface accelerating flow to the turbines.

19. A method as set forth in claim 17 wherein the wind turbines and supporting structures are manufactured off-site and transported to the base of the tower.

20. A method as set forth in claim 16 wherein the wind turbines and their supporting structures are substantially completely manufactured on site about the base of the tower.

21. A method as set forth in claim 16 wherein the wind turbines and their supporting structures are manufactured off-site in sections, and wherein the sections are transported to the site and assembled sequentially about the tower base and thereafter raised and secured in position.

22. A method as set forth in claim 21 wherein the sections are no larger than that allowed for truck transport.

23. A method as set forth in claim 16 wherein a power-lifting device is provided at the top of the tower for raising the wind turbine and supporting structure

24. A tower for mounting wind turbine supporting structure which at least partially envelops the tower at an elevated position for enhanced wind velocity; the tower comprising a plurality of horizontally spaced apart vertically extending narrow elongated and lightweight members and a plurality of shorter narrow lightweight interconnecting cross members extending between the vertical members and cooperating therewith to form a massive monolithic structure having a vertical dimension of at least thirty five (35) feet, the exterior cross sectional configuration and dimensions of the tower from its base to the area of attachment of the wind turbine supporting structure being less than that of the adjacent interior cross sectional surfaces of the wind turbine supporting structure, at least one power operated lifting device mounted substantially at the top of the tower and having at least one lift line extending downwardly therefrom, a plurality of diagonally extending outriggers adapted to be attached to the tower after the turbine and supporting structure has been positioned at the base of the tower, raised to its respective operating position by said lifting device and secured in place, the outriggers being spaced apart horizontally about the base of the tower and each being of narrow elongated and lightweight but longitudinally rigid construction, each outrigger having its upper end portion connected to the tower in supporting relationship therewith and its lower end portion disposed in horizontally spaced relationship with the tower at least approximately at ground level, and a foundation system supporting each vertical structural member of the tower and each outrigger at its lower end portion.

25. A foundation system for a tower for supporting wind turbines; the tower comprising a plurality of horizontally spaced apart generally vertically extending elongated members and a plurality of short interconnecting cross members extending between the generally vertical members and cooperating therewith to form a massive monolithic structure, and a plurality of diagonally extending outriggers spaced apart about the base of the tower and each of narrow elongated lightweight but longitudinally rigid construction, each outrigger having its upper end portion connected to the tower in supporting relationship therewith and its lower end portion disposed in horizontally outwardly spaced relationship with the tower at least approximately at ground level; the foundation system comprising a plurality of individual foundation systems respectively supporting the vertical structural members of the tower and the outriggers at their lower end portions, each individual foundation system comprising at least one narrow elongated member of composite metallic and concrete construction, said foundation member having its upper end portion connected with its supported member and extending downwardly into the earth a substantial distance in angular relationship with it's associated structural member.

26. A foundation system as set forth in claim 1 wherein at least two narrow elongated members of composite metallic and concrete construction.

27. A foundation system for a tower for supporting wind turbines as set forth in claim 26 wherein a manifold is provided having at least one pair of generally vertical through openings respectively receiving and aligning upper end portions of the foundation members beneath and closely adjacent their respective connections with each of the tower structural members.

28. A foundation system for a tower for supporting wind turbines as set forth in claim 26 wherein the at least two foundation members extend angularly downwardly from upper to lower end portions in a generally inverted V shaped configuration relative to each other.

29. A foundation system for a tower for supporting wind turbines as set forth in claim 25 wherein three (3) foundation members are provided for each of the vertical structural members of the tower and each of the outriggers, and wherein manifolds are provided for the tower structural members with three openings receiving foundation members, the foundation members being substantially equally spaced from each other and each member having an inverted V shaped relationship with each of its associated members.

30. A foundation system for a tower for supporting wind turbines as set forth in claim 29 wherein each foundation member is a micro pile.

31. A foundation system for a tower for supporting wind turbines as set forth in claim 25 wherein each foundation member associated with a tower structural members is arranged at an angle displaced between 0 and 45 degrees from the centerline of the structural member.

32. A foundation system for a tower for supporting wind turbines as set forth in claim 31 wherein each outrigger is arranged at a substantial angle with respect to the tower, and each foundation member associated with an outrigger is arranged at an angle displaced between 0 and 45 degrees from the centerline of its supported outrigger.

33. A foundation system for a tower for supporting wind turbines as set forth in claim 32 wherein the tower structural members are vertical, and wherein the foundation members associated with said members extend at an angle of approximately 10 degrees from the vertical.

34. A foundation system for a tower for supporting wind turbines as set forth in claim 33 wherein each of the foundation members supporting an outrigger extends at an angle displaced approximately 3 degrees from the centerline of it's outrigger.

35. A foundation system for a tower for supporting wind turbines as set forth in claim 27 wherein each manifold is constructed of precast concrete.

36. A foundation system for a tower for supporting wind turbines as set forth in claim 35 wherein each manifold opening is somewhat larger in diameter than the portion of its foundation member received in the opening for passage of a drill, and wherein the space around each member is filled with a hardenable medium which on curing positively grips and secures the member in the opening.

37. A foundation system for a tower for supporting wind turbines as set forth in claim 29 wherein a manifold type bracket is provided for connecting each tower structural member to its three foundation members and has lateral flange means with three openings respectively for receiving threaded upper end portions of the members which are secured by clamping nuts on opposite sides of the flange means, the bracket also having a connecting means at an opposite end secured to the lower end portion of the structural member of the tower.

38. A foundation system for a tower for supporting wind turbines as set forth in claim 29 wherein each outrigger comprises three parallel elongated tubular members, and wherein each tubular member has a flanged connection at its lower end with a short connecting tube in turn having an opening at its lower end for receiving an upper end portion of a threaded foundation member for inter connection of the tube and member by a pair of clamping nuts on opposite sides of the opening.

39. A method for providing individual foundations for generally vertical main structural members of towers for supporting wind turbines and for outriggers associated with the towers; said method comprising the steps of providing a template and manifold member having at least two top to bottom through openings for aligning an elongated tubular micro pile inner member subsequent to the drilling and concrete ejection portion of foundation formation, the concrete being sequentially deposited in and ejected from the tubular inner member to complete formation of the micro pile, and thereafter leaving upper end portions of the inner member of the micro pile exposed for connection with lower end portions of the tower structural members and its outriggers, the template and manifold thereafter serving to maintain the upper end portions of the micro piles in properly spaced and angular relationship with each other and in alignment with the lower end portions of the tower structural members and outriggers supported thereby.

40. A method as set forth in claim 39 wherein the template and manifold members are provided with through openings somewhat larger in diameter than the inner micro pile members to accommodate the drill bit, and wherein inserts are provided in the openings to serve as centering guides subsequent to drilling and prior to hardening of the concrete.

41. A method as set forth in claim 39 wherein annular openings in the template-manifolds between the micro pile members and the walls of the openings are filled with hardenable medium on completion of drilling to thereafter grip and secure the micro pile inner members in position.

42. A method as set forth in claim 41 wherein three openings are provided in each template and manifold member, and wherein three foundation members are provided and entered respectively in said openings.
